(19) United States
(12) Patent Application Publication
(10) Pub. No.: US 2020/0277040 A1
(43) Pub. Date: Sep. 3, 2020

(54) UNMANNED AERIAL VEHICLE

(71) Applicant: SZ DJI TECHNOLOGY CO., LTD., Shenzhen (CN)

(72) Inventors: Yifen LIU, Shenzhen (CN); Tianfei ZHAO, Shenzhen (CN)

(21) Appl. No.: 16/736,137

(22) Filed: Jan. 7, 2020

Related U.S. Application Data
(63) Continuation of application No. PCT/CN2017/108731, filed on Oct. 31, 2017.

(51) Int. Cl. B64C 11/46; B64C 29/00; B64C 27/08

(52) U.S. Cl. CPC B64C 11/46; B64C 2201/108; B64C 27/08; B64C 29/0091

(57) ABSTRACT

An unmanned aerial vehicle is provided in the present disclosure. The unmanned aerial vehicle includes an aircraft body, first arm assemblies disposed at a front of the aircraft body, and second arm assemblies disposed at a rear of the aircraft body. The first arm assemblies include first arms, and the second arm assemblies include second arms. The first arms and the second arms are rotatably connected to the aircraft body respectively, to enable each of the first arms and the second arms to be at an unfolded state or a folded state. When the first arm assemblies and the second arm assemblies are at the folded state, the first arms and the second arms are arranged side by side.

### CROSS-REFERENCE TO RELATED APPLICATION

This application is a continuation of International Application No. PCT/CN2017/108731, filed Oct. 31, 2017, the entire content of which is incorporated herein by reference.

### TECHNICAL FIELD

The present disclosure relates to the field of unmanned aerial vehicle technology and, more particularly, to an unmanned aerial vehicle with foldable arms.

### BACKGROUND

Unmanned aerial vehicles have advantages of flexible maneuverability, fast response, unmanned flight, low operation requirements, and the like. Therefore, the unmanned aerial vehicles are widely used in military, scientific research, and civil fields to perform tasks in various application fields, including transportation, delivery, surveillance, reconnaissance, exploration, photographing, and the like.

Arms are used to mount propulsion components in existing unmanned aerial vehicles and may be affixed to an aircraft body by bonding, integral molding and the like. As a result, the arms may not be disassembled from the aircraft body, or specific tools are required for the cumbersome procedure for dissembling arms from the aircraft body. Thus, it is impossible for a user to disassemble the arms in some cases. The storage and transportation of the unmanned aerial vehicles in a non-operation state may be extremely inconvenient, and the arms and the propulsion components may be easily damaged.

### SUMMARY

In accordance with the disclosure, an unmanned aerial vehicle is provided in the present disclosure. The unmanned aerial vehicle includes an aircraft body, first arm assemblies disposed at a front of the aircraft body, and second arm assemblies disposed at a rear of the aircraft body. The first arm assemblies include first arms, and the second arm assemblies include second arms. The first arms and the second arms are rotatably connected to the aircraft body respectively, to enable each of the first arms and the second arms to be at an unfolded state or a folded state. When the first arm assemblies and the second arm assemblies are at the folded state, the first arms and the second arms are arranged side by side.

### BRIEF DESCRIPTION OF THE DRAWINGS

In order to more clearly illustrate technical solutions in embodiments of the present disclosure, drawings required for describing the embodiments are briefly illustrated hereinafter. Obviously, the following drawings are merely examples for illustrative purposes according to various disclosed embodiments of the present disclosure and are not intended to limit the scope of the present disclosure. Those skilled in the art may obtain other drawings according to the drawings of the present disclosure without any creative efforts.

FIG. 1 illustrates a structural schematic of an unmanned aerial vehicle according to exemplary embodiments of the present disclosure;

FIG. 2 illustrates a bottom-view of an unmanned aerial vehicle according to exemplary embodiments of the present disclosure;

FIG. 3 illustrates a structural schematic of an unmanned aerial vehicle with unfolded arms according to exemplary embodiments of the present disclosure;

FIG. 4 illustrates a structural schematic of an unmanned aerial vehicle when arms are in a process of being folded according to exemplary embodiments of the present disclosure;

FIG. 5 illustrates a cross sectional schematic of a connection part between a second arm and a rotating axle bracket according to exemplary embodiments of the present disclosure; and

FIG. 6 illustrates a structural schematic of an unmanned aerial vehicle after arms are folded according to exemplary embodiments of the present disclosure.

### DETAILED DESCRIPTION OF THE EMBODIMENTS

The technical solutions in the embodiments of the present disclosure are clearly and completely described in the following with reference to the accompanying drawings in the embodiments of the present disclosure. It is obvious that the described embodiments are merely a part of the embodiments of the present disclosure, but not all embodiments. All other embodiments, based on the embodiments of the present disclosure, obtained by those skilled in the art without creative efforts are within the scope of the present disclosure.

Exemplary embodiments illustrated in the accompanying drawings are described in detail herein. When the accompanying drawings are described, same numerals in different drawings refer to same or similar elements unless otherwise indicated. The embodiment methods described in the following exemplary embodiments do not represent all embodiments consistent with the present disclosure. Instead, such embodiments are merely examples of devices and methods consistent with aspects of the disclosure as detailed in the appended claims.

The terminology used in the present disclosure is merely for the purpose of describing particular embodiments and is not intended to limit the disclosure. The singular forms “a”, “said”, and “the” used in the present disclosure and the appended claims may also include plural forms, unless the context clearly indicates other meanings. It will also be understood that the term “and/or” as used in the present disclosure may refer to and encompass any and all possible combinations of one or more of associated listed items.

The unmanned aerial vehicle of the present disclosure may be described in detail with reference to the drawings hereinafter. In case of no conflict, following embodiments and features of the embodiments may be combined with each other.

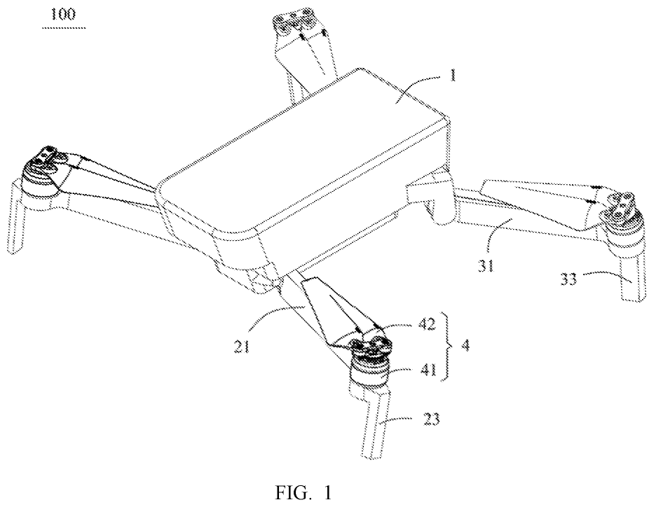

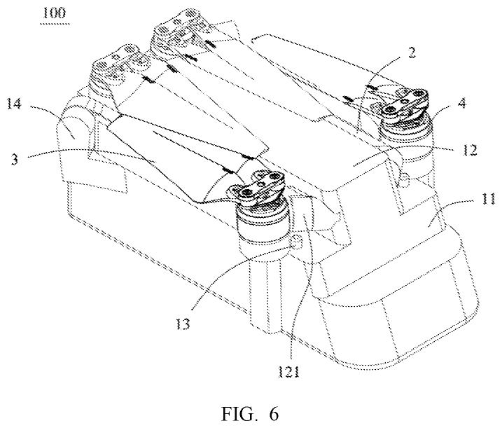

As shown in FIG. 1 and FIG. 6, an unmanned aerial vehicle 100 provided in the embodiments of the present disclosure may include an aircraft body 1, first arm assemblies 2 disposed at the front of the aircraft body 1, and second arm assemblies 3 disposed at the rear of the aircraft body 1. The first arm assemblies 2 may include first arms 21, and the second arm assemblies 3 may include second arms 31. The first arms 21 and the second arms 31 may be rotatably connected to the aircraft body 1 respectively, which may enable the first arms 21 and the second arms 31 to be at an unfolded state or a folded state. In the present disclosure, the space of the unmanned aerial vehicle 100 with folded arms may be minimized by using the foldable arm configuration, which may be convenient for users to store and transport the unmanned aerial vehicle, thereby protecting the unmanned aerial vehicle 100.

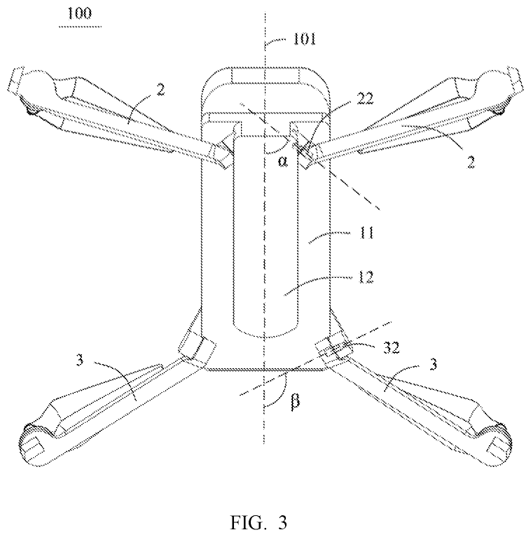

For example, when the unmanned aerial vehicle 100 is in operation, the first arms 21 and the second arms 31 may be unfolded to a maximum unfolding range (shown in FIG. 3), that is, the first arms 21 and the second arms 31 are at the unfolded state. When the unmanned aerial vehicle 100 is not in operation, the first arms 21 and the second arms 31 may be rotated relative to the aircraft body 1, thus the first arms 21 and the second arms 31 may be attached on a circumferential side of the aircraft body 10 (shown in FIG. 6), that is, the first arms 21 and the second arms 31 are at the folded state.

When the first arm assemblies 2 and the second arm assemblies 3 are all at the folded state, the first arms 21 and the second arms 31 may be arranged side by side, that is, the first arms 21 and the second arms 31 may on a same plane. Optionally, the first arms 21 and the second arms 31 may be arranged side by side along a horizontal direction. It should be noted that the horizontal direction herein may be for a state that the aircraft body 1 is squared. In one embodiment, the first arms 21 and the second arms 31 may be disposed at both sides of the aircraft body 1, and the first arms 21 and the second arms 31 at both sides of the aircraft body 1 may be arranged side by side. Furthermore, in order to enable the overall structure of the unmanned aerial vehicle 100 to be compact, the first arms 21 and the second arms 31 may be firmly attached to each other, and also integrally attached to the aircraft body 1.

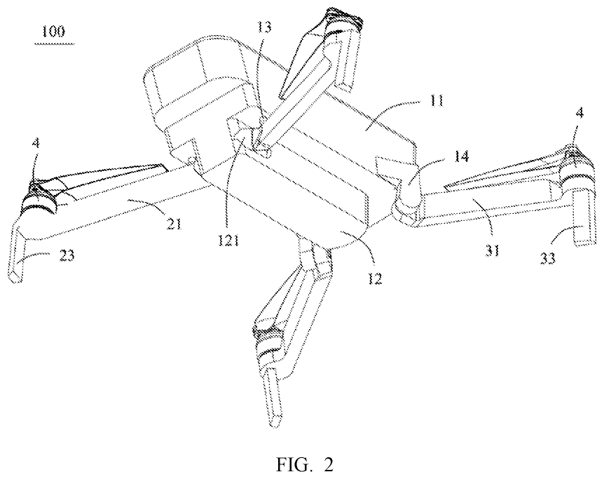

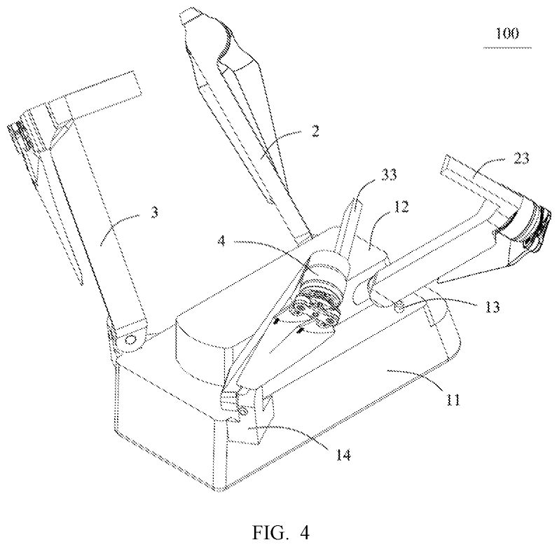

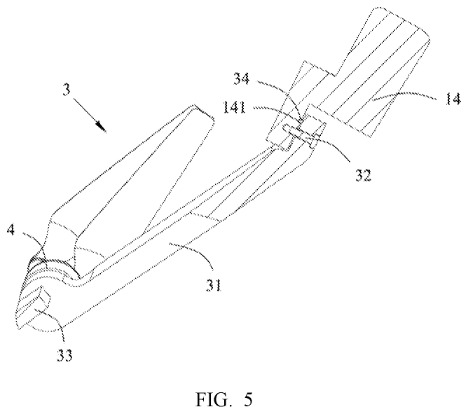

As shown in FIGS. 1-6, the aircraft body 1 of the unmanned aerial vehicle 100 may include a main body 11 and a protrusion part 12 protruding from a bottom of the main body 11. Th protrusion part 12 may be located at a middle position of the main body 11, thus the protrusion part 12 may be matched with the main body 11 to form an accommodation space at two sides of the protrusion part 12. When the first arm assemblies 2 and the second arm assemblies 3 are at the folded state, the first arm 21 and the second arm 31 on a same side of the aircraft body 1 may be located in the accommodation space side by side, thereby further protecting the first arms 21 and the second arms 31.

In one embodiment, the first arm assemblies 2 may be rotatably connected to the protrusion part 12, and the second arm assemblies 3 may be rotatably connected to the main body 11; such configuration manner may enable the first arms 21 to be attached to the protrusion part 12 when the first arm assemblies 2 are at the folded state, and also enable the second arms 31 to be attached to the first arms 21 when the first arm assemblies 2 are at the folded state.

In some optional embodiments, the quantity of the first arm assemblies 2 and the quantity of the second arm assemblies 3 may both be two; the two first arm assemblies 2 may be disposed on two sides of the protrusion part 12; and the two second arm assemblies 3 may be disposed at the main body 11. When the first arm assemblies 2 and the second arm assemblies 3 are at the folded state, the two first arms 21 may be attached on two sides of the protrusion part 12, and the two second arms 31 may be located at outer sides of same-side first arms 21. The unmanned aerial vehicle 100 may be an unmanned aerial vehicle 100 with four propellers 42 (e.g., including the two first arms 21 and the two second arms 31), as an example to describe the unmanned aerial vehicle of the present disclosure in detail hereinafter.

Correspondingly, the aircraft body 1 may further include connection parts 121 disposed at the protrusion part 12 for a cooperative connection with the first arms 21. The first arm assemblies 2 may further include first rotating axles 22 for connecting the first arms 21 with the connection parts 121, and each of the first arms 21 may rotate around one of the first rotating axles 22. First axle holes cooperatively connected to the first rotating axles 22 may be disposed at the connection parts 121. The first rotating axles 22 may be connected and limited to the first axle holes, and each of the first rotating axles 22 may rotate in one of the first axle holes. In one embodiment, an angle α between the axial direction of the first axle hole (e.g., the axial direction of the first rotating axle 22) and the central axis 101 of the aircraft body 1 may be 56°, thus each of the first arms 21 may have a better unfolding angle at the unfolded state, and may be attached on the aircraft body 1 at the folded state, thereby satisfying the design requirements that the unmanned aerial vehicle 100 is capable for minimizing space.

Furthermore, the first arm assemblies 2 may further include stopper parts 13 disposed at the aircraft body 1, and each of the stopper parts 13 may be located at a rotating path of one of the first arms 21. When the first arms 21 are at the unfolded state, the first arms may be abutted against the stopper parts 13 to limit rotating angles of the first arms 21. When the first arms 21 are at the folded state, the first arms 21 may be attached on the aircraft body 11. In one embodiment, by the limitation of the stopper parts 13, the first arms 21 may be at the horizontal direction when the first arms 21 are at the unfolded state; currently, a distance between two propeller components 4 may be maximum, thereby minimizing the interference between a plurality of propeller components 4.

In some optional embodiments, the aircraft body 1 may further include rotating axle brackets 14 disposed at the main body 11 for a cooperative connection to the second arms 31. The second arm assemblies 3 may further include second rotating axles 32 for connecting the second arms 31 with the rotating axle brackets 14. Each of the second arms 31 may be connected to an inner side surface of one of the rotating axle brackets 14 and may rotate around one of the second rotating axles 32. In one embodiment, the rotating axle brackets 14 may be disposed at sides of the main body 11 for a cooperative connection to the second arm assemblies 3. The second arm assemblies 31 may be connected inner side surfaces of the rotating axle brackets 14, thereby protecting the second arms 31 when the second arms 31 are folded.

Second axle holes cooperatively connected to the second rotating axles 32 may be disposed at the rotating axle brackets 14. An angle β between the axial direction of the second axle hole (e.g., the axial direction of the second rotating axle 32) and the central axis 101 of the aircraft body 1 may be 118°, thus each of the second arms 31 may have a better unfolding angle at the unfolded state, and may be attached on one of the first arms 21 at the folded state, thereby satisfying the design requirements that the unmanned aerial vehicle 100 is capable for minimizing space.

Furthermore, the second arm assemblies 3 may further include limiting blocks 34 disposed at the second arms 31 and limiting trenches 141 disposed at the rotating axle brackets 14. Obviously, the limiting blocks 34 may be disposed at the rotating axle brackets 14 and the limiting trenches 141 may be disposed at the second arms 31. When the second arm 31 is at the unfolded state, the limiting block 34 may fit into the limiting trench 141 to limit the position, thereby locking the second arm 31 at the unfolded state. When the second arm 31 is at the folded state, the second arm 31 may be disposed adjacent to the first arm 21 on a same side. In some optional embodiments, the limiting block 34 may adopt an elastic lock pin structure. The elastic lock pin may be retracted into the second arm 31 under the action of an external force and may be ejected from the surface of the second arm 31 after the external force is eliminated. A top of the elastic lock pin may be a round head structure, thus when the second arm 31 is subjected to a certain external force, the limiting block 34 may be detached from the limiting trench 141 to enable the second arm 31 to be folded.

In the present disclosure, the rotating axle bracket 14 may be disposed at the side of the main body 11 and may be bent and extended toward the bottom of the main body 11, which may enable the first rotating axle 22 of the first arm assembly 2 and the second rotating axle 32 of the second arm assembly 3 to be at a same horizontal plane, thereby satisfying the side by side arrangement of the first arm 21 and the second arm 31. The center line where the first rotating axle 22 is located may intersect the center line where the second rotating axle 32 is located.

In some optional embodiments, the first arm assemblies 2 may further include first drive devices disposed at the protrusion part 12, and the first drive devices may replace the above-mentioned connection parts 121. The first drive devices may be connected to the first arms 21 and may drive the first arms 21 to rotate, thereby enabling the first arms 21 to be at the unfolded state or the folded state. That is, the first drive devices may drive the first arms 21 to unfold or fold automatically by transmitting control signals from a controller to the first drive devices, which may not only simplify user's operation steps, but also increase product enjoyment and intelligence.

Furthermore, the second arm assemblies 3 may further include second drive devices disposed at the main body 11, and the rotating axle brackets 14 connected to the second arms 31 may be replaced by the second drive devices. The second drive devices may be connected to the second arms 31 and may drive the second arms 31 to rotate, thereby enabling the second arms 31 to be at the unfolded state or the folded state. That is, the second drive devices may drive the second arms 31 to unfold or fold automatically by transmitting control signals from a controller to the first drive devices. The first arms 21 and the second arms 31 may be controlled to be unfolded or folded simultaneously, thereby enabling the unmanned aerial vehicle 100 to be in operation or not in operation.

The axial direction of the drive axle of the first drive device may be the same as the axial direction of the first axle hole of the connection part 121, and the axial direction of the second drive device may be the same as the axial direction of the second axle hole, thus it may satisfy that the first arm assemblies 2 and the second arm assemblies 3 may be automatically unfolded or folded, or the first arms 21 and the second arms 31 may be arranged side by side. In the present disclosure, a drive device, which may cooperatively drive the first arm 21 and the second arm 31 to rotate to the folded state or the unfolded state, may be suitable for the first drive device and the second drive device of the present disclosure, which may not be limited in detail herein.

The unmanned aerial vehicle 100 may further include propeller components 4 respectively disposed at a free end of the first arm 21 and a free end of the second arm 31. Each of the propeller components 4 may include a drive unit 41 and the propeller 42 connected to the drive unit 41. The flying function of the unmanned aerial vehicle 100 may be implemented by driving the propellers 42 to rotate by the drive units 41. In one embodiment, the drive units 41 may be drive motors, and the drive motors may be disposed at all ends of the first arms 21 and the second arms 31.

Furthermore, the propellers 42 of the present disclosure may include folding blades, where the blades of the propellers 42 may be configured to be foldable. In such way, when the first arms 21 and the second arms 31 are folded, the blades of the propellers may also be folded, thereby protecting the blades from being damaged and also minimizing the space of the unmanned aerial vehicle 100.

A first stand 23, used for landing the unmanned aerial vehicle 100, may be disposed at the bottom of the first arm 21. A second stand 33, used for landing the unmanned aerial vehicle 100, may be disposed at the bottom of the second arm 31. The first stand 23 may be below the drive unit 41 of the first arm 21, and the second stand 33 may be below the drive unit 41 of the second arm 31. In one embodiment, the first arm 21 is attached on the protrusion part 12, thus the first stand 23 disposed at the first arm 21 may be configured to rotate, relative to the first arm 21, to be folded, thereby facilitating the folding of the first arm 21. The second arm 31 is at the outer side of the first arm 21, thus the second stand 33 of the second arm 31 may be configured to be folded or to be disposed near the side of the main body 11 according to requirements.

The unmanned aerial vehicle with foldable arms is provided in the present disclosure. The folding configuration of the unmanned aerial vehicle may be simple and reliable, and the space of the unmanned aerial vehicle may be minimized after folding the arms. Furthermore, the protection of the arms may be enhanced, which may prevent the arms from being damaged during storage and transportation.

It should be noted that, in the present disclosure, relationship terms such as first, second and the like are merely used to distinguish one entity or operation from another entity or operation, and do not necessarily require or imply any such relationship or sequence between the entities or operations. The terms “including”, “comprising” or other variants thereof are intended to encompass non-exclusive inclusions, thus a process, a method, an item or an device including a series of elements may include such elements, but also include other elements which are not explicitly listed, or include elements which are inherent to the process, the method, the item, or the device. Without additional restrictions, elements defined by the phrase “include a . . .” does not exclude the presence of additional same elements in the process, the method, the item, or the device including the series of elements.

The unmanned aerial vehicle provided by the embodiments of the present disclosure is described in detail above. The principles and embodiment methods of the present disclosure are described with reference to specific embodiments, and the description of the above-mentioned embodiments is merely for understanding the essential concept of the present disclosure. Meanwhile, the implementation manner and the application scope may be changed by those skilled in the art according to the concept of the present disclosure. The contents of the specification should not be construed as limiting the scope of the disclosure.

The content disclosed in the patent document contains materials which are subject to copyright protection, and the copyright is owned by the copyright owner. The copyright owner has no objection to the facsimile reproduction by anyone of the patent document or the patent disclosure as it appears in the official records and archives of the patent and trademark office.

What is claimed is:

1. An unmanned aerial vehicle, comprising:
an aircraft body, first arm assemblies disposed at a front of the aircraft body, and second arm assemblies disposed at a rear of the aircraft body, wherein:
the first arm assemblies include first arms, and the second arm assemblies include second arms;
the first arms and the second arms are rotatably connected to the aircraft body, respectively, to enable each of the first arms and the second arms to be at an unfolded state or a folded state; and
when the first arm assemblies and the second arm assemblies are at the folded state, the first arms and the second arms are arranged side by side.

2. The unmanned aerial vehicle according to claim 1, wherein:
first rotating axles of the first arms and second rotating axles of the second arms are on a same plane.

3. The unmanned aerial vehicle according to claim 2, wherein:
a center line of a first rotating axle intersects a center line of a second rotating axle.

4. The unmanned aerial vehicle according to claim 1, wherein:
the aircraft body includes a main body and a protrusion part protruding from a bottom of the main body, wherein:
the first arm assemblies are rotatably connected to the protrusion part; and
the second arm assemblies are rotatably connected to the main body.

5. The unmanned aerial vehicle according to claim 4, wherein:
a quantity of the first arm assemblies is two and a quantity of the second arm assemblies is two; the two first arm assemblies are disposed at two sides of the protrusion part; and the two second arm assemblies are disposed at the main body.

6. The unmanned aerial vehicle according to claim 5, wherein:
when the first arm assemblies and the second arm assemblies are at the folded state, two first arms of the two first arm assemblies are attached on the two sides of the protrusion part, and two second arms of the two second arm assemblies are located at outer sides of same-side first arms.

7. The unmanned aerial vehicle according to claim 5, wherein:
the aircraft body further includes connection parts, disposed at the protrusion part for a cooperative connection with the first arms.

8. The unmanned aerial vehicle according to claim 7, wherein:
the first arm assemblies further include first rotating axles for connecting the first arms with the connection parts, and each of the first arms rotates around one of the first rotating axles.

9. The unmanned aerial vehicle according to claim 8, wherein:
first axle holes are cooperatively connected to the first rotating axles and are disposed at the connection parts, wherein an angle α between an axial direction of a first axle hole and a central axis of the aircraft body is about 56°.

10. The unmanned aerial vehicle according to claim 5, wherein:
the first arm assemblies further include stopper parts disposed at the aircraft body, and each of the stopper parts is located at a rotating path of one of the first arms; and
when the first arms are at the unfolded state, the first arms are abutted against the stopper parts; and when the first arms are at the folded state, the first arms are attached on the aircraft body.

11. The unmanned aerial vehicle according to claim 5, wherein:
the aircraft body further includes rotating axle brackets disposed at the main body, and the rotating axle brackets are cooperatively connected to the second arms.

12. The unmanned aerial vehicle according to claim 11, wherein:
the second arm assemblies further include second rotating axles for connecting the second arms with the rotating axle brackets; and
each of the second arms is connected to an inner side surface of one of the rotating axle brackets through a second rotating axle, and each of the second arms rotates around one of the second rotating axles.

13. The unmanned aerial vehicle according to claim 12, wherein:
second axle holes are cooperatively connected to the second rotating axles and are disposed at the rotating axle brackets, wherein an angle β between an axial direction of a second axle hole and a central axis of the aircraft body is about 118°.

14. The unmanned aerial vehicle according to claim 11, wherein:
the second arm assemblies further include limiting blocks disposed at the second arms, and limiting trenches are disposed at the rotating axle brackets; and
when the second arms are at the unfolded state, the limiting blocks fit into the limiting trenches to limit positions; and when the second arms are at the folded state, the second arms are disposed adjacent to same-side first arms.

15. The unmanned aerial vehicle according to claim 5, wherein:
the first arm assemblies further include first drive devices disposed at the protrusion part; and
the first drive devices are connected to the first arms and drive the first arms to rotate to enable the first arms to be at the unfolded state or the folded state.

16. The unmanned aerial vehicle according to claim 5, wherein:
the second arm assemblies further include second drive devices disposed at the main body; and 6p1 the second drive devices are connected to the second arms and drive the second arms to rotate to enable the second arms to be at the unfolded state or the folded state.

17. The unmanned aerial vehicle according to claim 1, further including:
propeller components respectively disposed at free ends of the first arms and free ends of the second arms, wherein each of the propeller components includes a drive unit and a propeller connected to the drive unit.

18. The unmanned aerial vehicle according to claim 17, wherein:
the propeller includes blades, wherein the blades of the propeller are foldable.

19. The unmanned aerial vehicle according to claim 1, wherein:
first stands, used for landing the unmanned aerial vehicle, are disposed at bottoms of the first arms; and
second stands, used for landing the unmanned aerial vehicle, are disposed at bottoms of the second arms.
